(19) United States
(12) Patent Application Publication
(10) Pub. No.: US 2004/0094516 A1
(43) Pub. Date: May 20, 2004

(54) Method for real time dynamic diagnosis and decision assistance, for an electric direct spark butt electric welder and its weld seams

(76) Inventors: Jean Marie De Pra, Jemeppe-Sur-Meuse (BE); Eugene Butenko, Grace-Hollogne (BE); Gilbert Roggen, Embourg (BE)

Correspondence Address: Jacobson Holman, Professional Limited Liability Company, The Jenifer Building, 400 Seventh Street NW, Washington, DC, 20004, US

(21) Appl. No.: 10/344,693

(22) PCT Filed: Sep. 25, 2001
(86) PCT No.: PCT/BE01/00166

(30) Foreign Application Priority Data
Sep. 26, 2000 (EP) 00870217.7

(51) Int. Cl. B23K 11/04

(52) U.S. Cl. 219/109; 219/110; 219/97

(57) ABSTRACT

A process for the acquisition of data in the form of measurements and calculations, for diagnosis and decision assistance for an electric direct spark butt welder and for the resulting weld seams comprises the respective steps of measurement of the instantaneous alternating voltage at the terminals of the primary (19, 33) and of the secondary (16, 35, 36) of the welder transformer, and between the jaws (18, 39) of the welder dies; measurement of the instantaneous current in the primary (24, 34) and the secondary (17, 37, 38) of the transformer; measurement of the instantaneous displacement (41, 42) of the mobile die (4); storage in memory of said voltages, said currents and said displacement during the welding process; calculations of the energy supplied by the primary and the secondary, preferably to the jaws (5, 6), as a function of time; calculation of the energy supplied by the secondary to the jaws and of the heat energy dissipated during sparking as a function of the displacement of the mobile die; calculation of energy yields and, on the basis of these measurements and calculations, automatic establishment of a real-time dynamic diagnosis (68, 74, 78, 79, 80), with or without the interactive intervention of an operator, as regards the quality of at least one weld seam that has just been formed on said welder.

### SUBJECT OF THE INVENTION

The present invention relates to a new process for real-time dynamic diagnosis for an electric direct spark butt welder and for the weld seams obtained with such equipment.

The present invention likewise relates to the electric direct spark butt welder on which the process is implemented.

### PRIOR ART

Butt welding is known and is distinguished from other conventional spot-welding and contact-roller processes not only in its operating mode but above all by the fact that the weld seam extends across the entire section of the two assembled pieces, thus forming a single piece that is perfectly continuous as regards its geometric dimensions, that is substantially homogeneous from the metallurgical point of view and that has virtually uniform mechanical strength.

This process allows to achieve rectilinear joining of rounds, squares, various profiles, tubes, strips, etc. and the assembly of pieces forming a certain angle between them (most frequently 90°).

The quality of the weld seams achieved by the butt welding technique is fundamental in a certain number of cases. Indeed, in continuous processes especially, such as rolling for instance, the weld seams have to withstand the stresses to which they are subjected. Otherwise, significant losses of productivity may be observed as well as deterioration of the tools due to successive breaks of the weld seams. The importance of the quality of the weld seams is obviously not limited to continuous processes: the quality of the weld seams is fundamental to the implementations of the products on the client's side.

During the production of steel strip, it is necessary to butt weld, in the course of production, the strips, which are thus continuously unwound in order to ensure uninterrupted processing of the product. The process of continuous pickling or of continuous rolling may be mentioned here as examples. In these processes, it is very important to ensure this continuity in processing in order to maintain high product quality, to obtain significant productivity and to reduce the production costs. An accumulator positioned after the welder and pre-loaded with the product to be processed allows to avoid an interruption in the treatment process during the welding operation.

The following disadvantages may be identified when a weld seam breaks in these processes:

loss of production due to the interruption caused by the break;

damage caused to the tool by this break;

loss of product quality;

risk of injury to the staff when threading the strip;

loss of reliability of the weld seam.

If there is any doubt about the quality of the weld seam after it has been formed, the welder operator can only stress it mechanically in order to test its strength. Of course, this test is not sufficient and not very reliable. Moreover, it takes a certain amount of time, thereby further reducing the productivity of the production line.

Nowadays, the existing means for determining the quality of weld seams are thus very rudimentary and do not allow precise, accurate or exact analysis in real time on the welder. The known means of investigation are-limited to the storage in memory of some signals and to the display of the evolution line in the course of time of a number of measured values.

Thus, within the context of electric direct spark butt welders, the electric values, such as current or voltage, that are usually measured and evaluated, are those of the primary. The secondary voltage(s) of the transformer(s) supplying the electric circuit constituted by possible supply cables, the stacks, the dies, the jaws, the product and its actual faces to be welded, are sometimes measured as well. In no case are the measurements of the instantaneous secondary currents evaluated, for example as part of automatic and systematic diagnosis relating to the validity of a direct spark butt weld seam before it is allowed to enter the continuous process that follows the welder.

When operating in this way, no detailed analysis can be carried out because it is not possible to distinguish between the above-mentioned various parts without evaluating the instantaneous measurements of the various secondary currents and voltages. Thus, for example, the balance of electric energy transfer from the primary to the secondary of the transformer and to the vicinity of the actual faces to be welded cannot truly be quantified without evaluating instantaneous measurements of the current and voltage acquired at different points of the primary and the secondary circuit. Without evaluating instantaneous measurements of the secondary current and voltage, the balance of energy transfer measured at the primary of the transformer cannot be used to extrapolate the distribution of energy to the secondary and/or to the vicinity of the actual faces to be welded. If this were necessary, it would take place on the basis of false assumptions. The dependency as regards the characteristics of the transformer, of its complex behaviour in transient operation, of the electromechanical state of the windings, of the dies, of the stacks, of the jaws and of the product makes this calculation very risky. Indeed, without instantaneous measurements of secondary currents and voltages and their evaluation, it is not possible to quantify with sufficient accuracy the distribution of the various electric losses from the origin (primary of the transformer) to the vicinity of the actual faces to be welded. Moreover, the knowledge of the energy establishment in the vicinity of the jaws as a function of the space travelled and of time would only be approximate and it would not be possible to use it in order to diagnose possible energy-related defects. This manner of proceeding would make inaccurate any diagnosis relating to the welder and to the obtained weld seam.

The prior art does not mention any analysis or evaluation of the acquired signals that would allow an operator to:

immediately act on the produced weld seam before sending it to the continuous process after the welder;

immediately test after welding a new diagnosis made on the basis of more pertinent data and to immediately benefit from the result without redoing the weld seam;

modify the parameters governing the welding process in order then to adapt them better to the type of welded product;

know the electromechanical state of the welder.

Finally, the available systems are in a sense both “judge and judged” since the performed measurements are used, on the one hand, to regulate the welder and, on the other hand, to draw evolution lines that could be used for analysis a posteriori. The use of the same electric signals obviously entails a lack of control since the aim of regulation is to enable one (or several) value(s) to follow the desired progression.

### AIMS OF THE INVENTION

The present invention aims to solve the above-mentioned disadvantages of the prior art.

In particular, the invention aims to propose a new process for real-time dynamic diagnosis for an electric direct spark butt welder and for the weld seams obtained with this equipment in the various applications of direct spark butt welding technique, whether by a continuous or discontinuous process, whether using alternating, pulsed, quasi-direct or direct current, i.e. with rectification of the secondary voltages by diode bridges, before electric supply to the jaws, for a round, square or rectangular product section or for a product of the flat-strip type, etc.

Additionally, the process of the present invention aims to solve the above-mentioned problems without interfering with conventional butt welding operations in the frame within which it can be used.

### MAIN CHARACTERISTIC ELEMENTS OF THE INVENTION

The present invention relates to a process for the acquisition of data in the form of measurements and calculations, for real-time dynamic diagnosis and decision assistance for an electric direct spark butt welder and for the weld seams obtained by means of said welder; said welder being incorporated into a preferably continuous steel production process, and comprising at least one transformer including at least one primary circuit and at least one secondary circuit as well as a clamping device with dies, of which one die is fixed and one die is mobile, allowing to maintain at least two pieces to be welded and inserted in series in the secondary circuit of the transformer, said secondary circuit furthermore including at least one secondary winding of said transformer, input and output connections of the secondary winding, stacks, said dies and jaws, the primary and secondary circuits being provided with current and voltage sensors; comprising the following steps:

measurement of the instantaneous alternating voltage, which is preferably sinusoidal, at the terminals of the primary of the welder transformer;

measurement of the instantaneous alternating voltage at the terminals of the secondary of the transformer and between the jaws of the welder dies;

measurement of the instantaneous current in the primary and the secondary of the transformer;

measurement of the instantaneous displacement of the mobile die at at least two points;

storage in memory of said voltages, said currents and said displacement during the welding process;

calculation of the energy supplied by the primary as a function of time;

calculation of the energy supplied by the secondary, preferably to the jaws, as a function of time;

calculation of the energy supplied by the secondary to the jaws as a function of the displacement of the mobile die;

calculation of the heat energy dissipated during sparking, referred to as material energy, as a function of the displacement of the mobile die;

calculation of the secondary/primary; jaw/secondary;

jaw/primary and jaw/material energy yield for at least a given duration;

on the basis of said measurements and said calculations, automatic establishment of a real-time dynamic diagnosis, with or without the interactive intervention of an operator, as regards the quality of at least one weld seam that has just been formed on said welder.

The process preferably also includes the following steps:

calculation of the energy supplied by the primary for at least a given duration;

calculation of the energy supplied by the secondary for at least a given duration;

calculation of the energy supplied by the secondary to the jaws for at least a given duration.

Direct spark welding applies to a continuous or discontinuous steel production process. It can be performed using alternating, pulsed, quasi-direct or direct current. Finally, it is preferably used for products with a round, square or rectangular section, for flat strips or for tubular products. More particularly, the technical field covered by the invention relates to direct spark butt welding of steel strip in a continuous process, preferably pickling or continuous rolling.

According to a preferred embodiment of the invention, the process is implemented on a welder comprising a mobile die actuated in the direction of a fixed die by means of hydraulic cylinders, themselves actuated by a hydraulic control circuit, a differential pressure sensor being arranged on the cylinders, a pressure sensor being arranged at the outlet of hydraulic accumulators, two linear sensors being arranged in the deviation between the jaws, preferably the lower jaws, and furthermore includes the following steps:

instantaneous measurement of the displacement of the mobile die at at least two points and calculation of the differential displacement;

instantaneous measurement of the pressure at the outlet of the hydraulic accumulators;

instantaneous measurement of the differential pressure applied to the displacement cylinders;

storage in memory of said displacement and of said pressures during the welding process;

as a function of said displacement, calculation of the deviation of the mobile die at at least two points, referred to as obliquity, relative to the theoretical welding axis;

calculation of the mechanical welding forces during the sparking and forging phases.

In the process according to the invention for the acquisition of data in the form of measurements and/or calculations, said data are advantageously displayed on a computer screen, a control monitor or a processing station, preferably in colour, and evaluated in the form of a quality diagnosis.

In a particularly advantageous manner, the display of said data and their evaluation in the form of diagnosis allows an operator to visualise and/or analyse them in real time and constitutes a decision assistance for said operator with a view to validating or rejecting the weld seam which has just been formed.

Moreover, immediately after the welding operation, the operator has the opportunity to establish a new diagnosis on the basis of more pertinent data, preferably introduced by said operator and preferably linked to the geometry and weldability of the product to be welded, the result of which is immediately obtained without redoing the weld seam.

A curve of the energy dissipated as a function of displacement is advantageously and preferably obtained at a location as close as possible to the weld seam, said curve allowing immediate digital analysis leading to particularly pertinent energy-related diagnoses.

The operator can advantageously assess the quality of forging and the number of welding defects, preferably bonds and microbonds.

Still according to the invention, the weld seam can be rejected on the basis of quality and redone by the operator without the pieces to be welded having left the welding station to continue the production process.

The display of the data preferably allows an operator to analyse them in real time and to emit a diagnosis on the electromechanical state of the welder.

Alternatively, a decision to validate or reject the weld seam that has just been formed can be automatically taken in real time without the intervention of an operator.

More particularly, the invention relates to a process for the detection, quantification and qualification of bonding defects before forging, comprising the following steps:

search for local maxima in the curve formed by the measurements of instantaneous secondary current taken during successive time periods corresponding to the cyclic period of the voltage supplying the primary of the transformer;

counting, during sparking, of the number of times that said current maxima exceed a fixed percentage of the maximum forging current;

qualification of said defect on the basis of the value obtained.

This remarkable manner, according to the invention, of quantifying this type of defect does not depend either on the geometry of the product or on the characteristics of the sinusoidal voltage supplying the primary. It thus constitutes a major advantage of the present invention while at the same time imparting to it a universal feature.

In accordance with the invention, a file of said data is created and stored in memory for each formed weld seam, the maintenance work performed on the welder is stored in memory.

Quality statistics are preferably established on a large number of formed weld seams, said statistics being displayed and containing the nature and the number of the welding defects.

According to a particular characteristic of the invention, signals are acquired at a rate such that, when a sinusoidal alternating voltage with a frequency of 50 or 60 hertz supplies the primary of the transformer, the characteristic acquisition time interval is between 0.01 and 2 ms, and preferably between 0.1 and 1 ms. Consequently, it is possible to perform detailed and precise analysis of the phenomena accompanying the process of butt welding.

Another aspect of the present invention relates to a device for displaying electronic data, preferably a computer screen, a control monitor or a development station, said data being obtained by means of the process according to the invention, or being introduced, preferably with a keyboard, by an operator, characterised in that the device comprises at least one zone for displaying a diagram (X, Y), one zone featuring the basic data of the products to be welded for a new welding sequence, after the automatic introduction or by said operator, and one diagnostic zone comprising values for predetermined welding parameters, the same parameters selected by the operator and the same parameters actually measured. The basic data on the products to be welded are, for the strip head and the strip tail, the weldability, thickness, width and section of the sheets to be welded.

The predetermined welding parameters are preferably selected from the group comprising the high voltage percentage, the welding time, the forging stroke, the contact of the transformer used, the cam or convexity of the displacement curve, the final space, the spacing bar and the number of cycles of forging current.

According to a particular embodiment of the device of the invention, this device comprises a display zone indicating the quality status of the weld seam. In the case where the quality of the weld seam is inadequate, the device is provided with a display zone indicating the cause of this inadequacy.

The diagrams (X, Y) advantageously include instantaneous values, which are absolute or differential, measured or calculated, and chosen from the group comprising voltages, currents, dissipated energy, energy yields relating to welding and die displacements, the measured values being acquired at different points of the welder. Statistics relating to a large number of weld seams already formed are displayed in diagrams-, such as pie charts, histograms or Pareto-type diagrams for instance.

The present invention likewise aims to propose an electric direct spark butt welder on which the above-described process is implemented.

The electric direct spark butt welder preferably comprises a device for displaying electronic data according to the invention.

### BRIEF DESCRIPTION OF THE DRAWINGS

FIG. 1 represents a diagrammatic view in vertical section of the direct spark butt welder according to the invention, showing the electric diagram, including the electric sensors.

FIG. 2 represents a diagrammatic view of the welder according to the invention from above showing a hydraulic diagram, including the pressure and position sensors. In particular, FIG. 2 shows the obliquity of the mobile die at a given point of its displacement.

FIG. 3 represents the electric diagram according to one particular embodiment of the invention, including the current sensors, which supply a signal relating to the instantaneous value of the measured current.

FIG. 4.a represents an example of the variation of the secondary current and voltage as a function of time, corresponding to a measurement acquisition frequency of 2000 hertz, for a sinusoidal alternating voltage with a frequency of 50 hertz supplying the primary of the welding transformer(s).

FIG. 4.b represents an example of calculation of the variation of the energy supplied by the secondary as a function of time, corresponding to an acquisition frequency of the secondary voltage and current measurements of 2000 hertz, for a sinusoidal alternating voltage with a frequency of 50 hertz supplying the primary of the welding transformer(s).

FIG. 5.a represents an example of a diagnostic screen that can be displayed after a weld seam has been formed, representing the displacement in the course of time of the mobile die in FIG. 2 at two different points as well as the differential displacement.

FIG. 5.b represents an example of a “mechanical” diagnostic screen that can be displayed after a weld seam has been formed, showing the obliquity of the mobile die as a function of its displacement in the course of the welding process.

FIG. 6 represents an example of a diagnostic screen that can be displayed before and after a weld seam has been formed, and allows to test the diagnosis upon changing basic data without redoing the weld seam.

FIG. 7 represents an example of a diagnostic screen displayed after a weld seam has been formed, in the case where a weld seam has to be checked.

FIG. 8 represents an example of a diagnostic screen identical to that in FIG. 7, which is displayed after a weld seam has been formed but relates to a good-quality weld seam.

FIG. 9.a represents an example of calculation of the variation of the energy supplied by the secondary as a function of time during the entire formation of a weld seam in a case where it has no defects.

FIG. 9.b represents an example of calculation of the variation of the energy supplied by the secondary as a function of time during the entire formation of a weld seam. In the case shown, a defect corresponding to a slight variation in energy in the first half of the total time is diagnosed.

FIG. 9.c represents an example of calculation of the variation of the energy supplied by the secondary as a function of the space travelled, during the entire formation of a weld seam. This allows the system to diagnose defects irrespective of the regulation type of the displacement of the mobile table during the entire formation of a weld seam.

FIGS. 10.a and 10.b are obtained on a development station on the basis of the recapitulative files generated after each weld seam, the contents of which are included in Table 3. The statistics are displayed in the form of a sector diagram or pie chart (FIG. 10.a) and a histogram (FIG. 10.b).

For the sake of making it easier to understand the problems to which the present invention provides original solutions, the case of direct spark butt welding of steel strip in a continuous process, such as pickling or continuous rolling, will be considered by way of example. However, it goes without saying that the original solutions described and implemented within the context of the invention can also be applied to the various above-mentioned industrial fields.

### DESCRIPTION OF A PREFERRED EMBODIMENT OF THE INVENTION

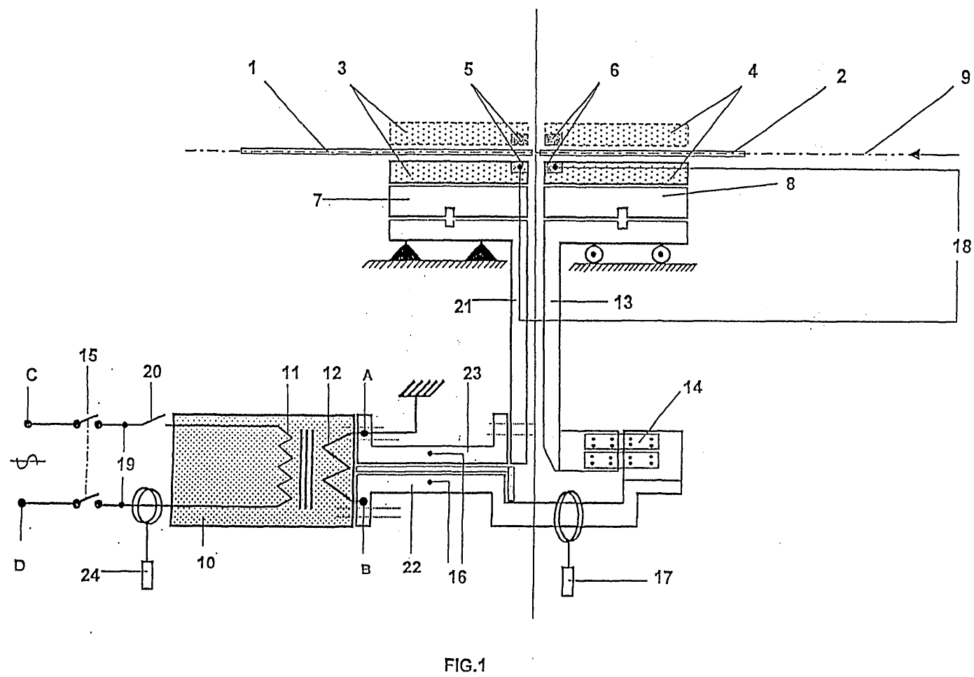

In the spark butt welding process, the two pieces to be welded 1, 2 are each clamped in a clamping device with dies 3, 4 (FIG. 1). These dies, which are directly or indirectly connected to the terminals of the secondary 12 of the welding transformer 10 ensure the passage of the welding current into the jaws 5, 6 and the two pieces to be welded 1, 2.

The primary circuit is constituted by a primary winding 11 supplied with sinusoidal alternating current (50 or 60 Hz) by the network via the terminals C, D. It is provided with at least one switch 20 and one circuit breaker 15.

The secondary electric circuit is constituted by the secondary winding 12, possible supply cables emerging from the latter, the connection points A and B, the stacks 22, 14, 13, 8, 7, 21, 23, the lower dies 3, 4, the lower jaws 5, 6, the product 1, 2 and its actual faces to be welded. The path of the secondary current is: connection point B, 22, the shunt 14, 13, 8, lower 4, lower 6, 2, 1, lower 5, lower 3, 7, 21, 23, connection point A. Respective voltage measurements 19, 16, 18 are performed at the terminals of the primary and secondary of the transformer and between the jaws 5, 6 of the lower dies. Current sensors 24, 17 respectively arranged in the primary and secondary circuits measure the corresponding currents.

To clarify the ideas involved, it will be assumed below that the installation includes one single transformer with one primary and one secondary. The actual installation includes several transformers if required, each of these including one or more primaries and/or secondaries.

The clamping of the pieces 1, 2 between the jaws 5, 6 should be sufficient to ensure good conduction of the welding current between the pieces and these jaws owing to low contact resistance and to prevent any sliding of the pieces between the jaws when a reverse force is applied thereon.

The left-hand clamping device 3 is fixed on a fixed table 7 firmly attached to the support structure of the machine, while the right-hand clamping device 4 is fixed on a mobile table 8, which moves parallel to the displacement axis 9 of the pieces to be welded.

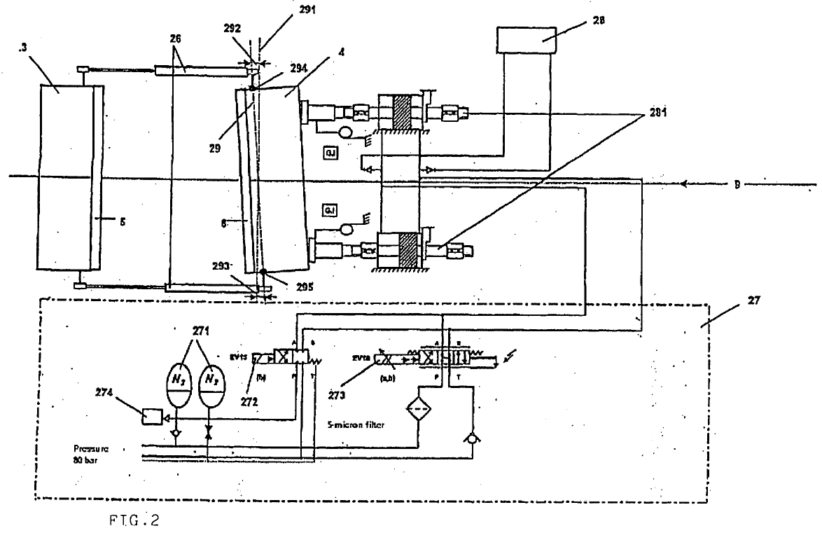

FIG. 2 gives a description of a mechanical and hydraulic diagram of a welder, in one particular embodiment, which is not restricted as regard the scope of the invention. The mobile die 4 is actuated towards the fixed die 3 by means of hydraulic cylinders 281. The hydraulic control circuit 27 of these cylinders comprises a servovalve 273, an electric forging valve 272, hydraulic accumulators 271 and a pressure sensor 274, supplying an electric signal related to the service pressure. An additional differential pressure sensor 28 is arranged on the cylinders 281. Two linear sensors 26 supply an electric signal related to the distance between their attachment points to the dies. These sensors allow to measure the distance between the dies and the offset of the mobile die.

During spark welding, the following operations are successively carried out:

clamping of the pieces to be welded 1, 2 (FIG. 1) between the jaws 5, 6 of the dies 3, 4. At this time, the ends to be assembled are not in contact or are in imperfect contact without pressure;

application of a voltage across the transformer, and, consequently across the pieces to be welded;

application of slow movement to the mobile table 8 and sparking phenomenon when the faces to be welded touch under slight pressure;

reverse force or forging after some displacement.

The mobile table 8 being in motion, the faces of the pieces to be welded come into contact under slight pressure. The secondary electric circuit is then closed by these few contact points, where the current density is very high. There is an intense heat release at these points, which rapidly melt. This phenomenon is characterised by the projection of particles or “sparks”, hence the name sparking. It continues for the entire duration of the advance of the mobile table, which maintains continuous contact between the pieces as material is expelled.

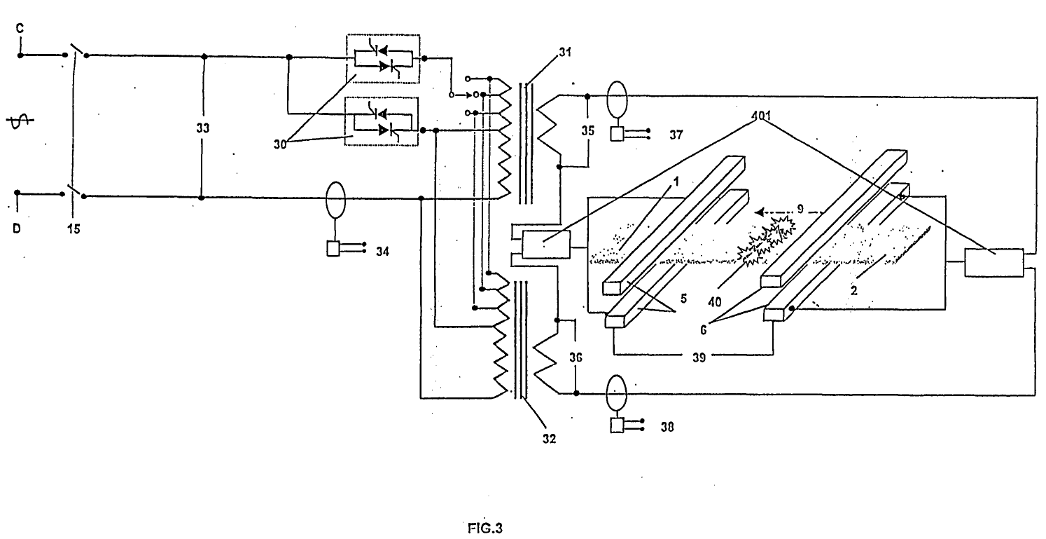

When the sparking stroke is completed, the ends to be assembled have reached the welding temperature and are strongly pressed against one another by rapid movement of the mobile table. This is the reverse or forging phase. During this phase, the welding current is maintained, totally or partially cut or sometimes prolonged beyond the end of mechanical forging. The clamping dies are released and the welded piece can be displaced. The switch(es) 20 (FIG. 1) present in the primary circuit of the transformer(s) can be replaced by electronic thyristor switches 30 (FIG. 3) with a variable firing angle.

The position of the various current and voltage sensors is indicated in FIG. 3 by way of example for one particular alternative embodiment including two transformers 31, 32 connected to the dies and to the jaws by the stacks 401. In the primary circuit, at least one total voltage 33 (Uₚ) and one total current 34 (Iₚ) are measured. In the secondary circuit, a voltage 35, 36 (Uₛ₁, Uₛ₂) is measured at each secondary winding and between the jaws 39 (Uₘ). The currents 37, 38 (Iₛ₁, Iₛ₂) corresponding to each secondary winding are likewise measured.

The real-time dynamic diagnosis for decision assistance for an electric direct spark butt welder and for its weld seams 40, which is the subject of the present invention, is in particular characterised in that pertinent electric values 33, 34, 35, 36, 37, 38, 39 (FIG. 3) are analysed and evaluated, not only at the primary of the transformer of the welder but also at the secondary of the latter and in the vicinity of the jaws 5 and 6 (FIG. 3) which grip the product to be welded. Moreover, these electric values, such as voltage and current, are acquired at a measurement acquisition frequency which is at least twenty times higher than the frequency of the sinusoidal alternating voltage supplying the primary of the welding transformer(s).

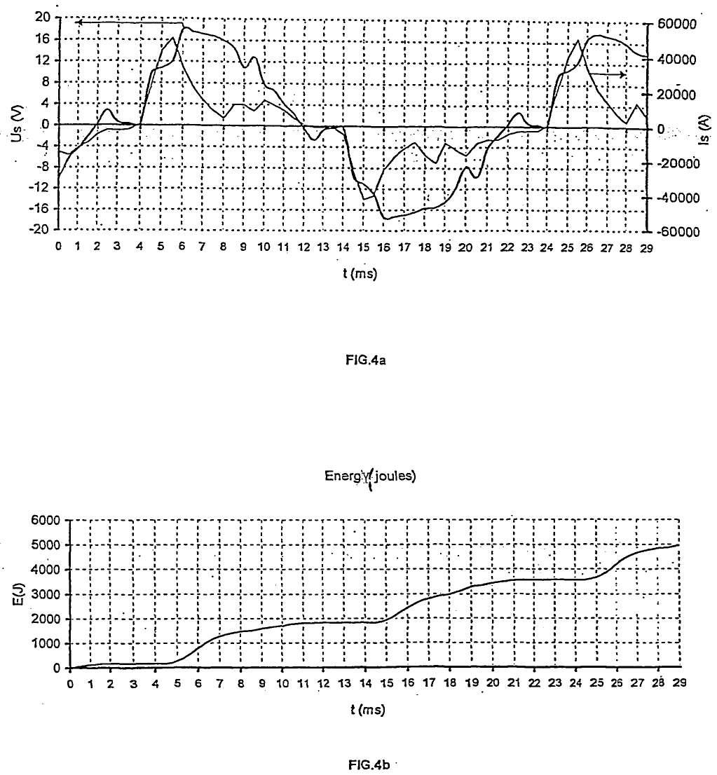

FIG. 4.a gives an example of secondary current and voltage measurement as a function of time when the measurement acquisition frequency is 2000 hertz and for a sinusoidal alternating voltage with a frequency of 50 hertz supplying the primary of the welding transformer(s). For the sake of good understanding, the duration corresponding to the fixed measurement acquisition frequency is symbolised by Δt(s), or by Δt.

Based on these values, the energy E(J) supplied during a determined time period is calculated (FIG. 4.b) The determined time period is obviously an integral multiple of Δt and an instantaneous voltage and current acquisition corresponds to each time interval Δt. In these conditions, E(J) represents the result of the calculation of the sum of the instantaneous current and voltage products multiplied by Δt.

In the case of FIG. 3, for a determined time period:

Eₚ=sum of Uₚ×Iₚ×Δt (=energy supplied by the primary during a determined time period);

Eₛ₁=sum of Uₛ₁×Iₛ₁×Δt (=energy supplied by the secondary 1 during a determined time period)

Eₛ₂=sum of Uₛ₂×Iₛ₂×Δt (=energy supplied by the secondary 2 during a determined time period);

Eₛ=Eₛ₁+Eₛ₂ (=total energy supplied by the secondaries during a determined time period);

Eₘ=sum of Uₘ×(Iₛ₁+Iₛ₂)×Δt (=energy during a determined time period supplied to the jaws 5, 6=welding energy during a determined time period).

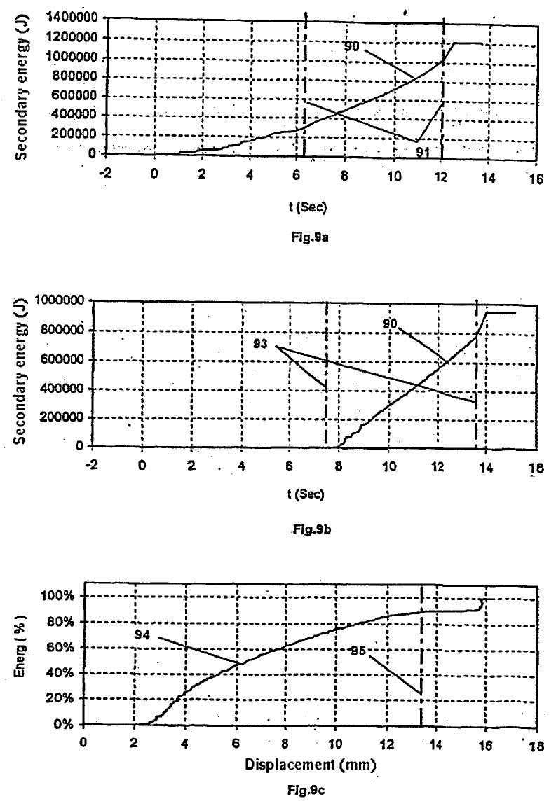

FIG. 9 shows the variation of the calculated energy 90, 94 supplied by the secondary as a function of time (FIG. 9.a and 9.b) and displacement (FIG. 9.c) respectively. The reference numerals 91 and 93 delimit a sparking period which precedes forging (FIG. 9.a and 9.b). The reference numeral 95 separates the sparking phase from the start of forging in FIG. 9.c.

On the basis of the energy calculations, it is possible, for example, to diagnose an unbalance in the distribution of energy as a function of time during sparking 90, which presumes poor geometrical presentation of the products to be welded (FIG. 9.b). It is also possible to diagnose a lack of energy as a function of displacement (FIG. 9.c) of the table with respect to the geometry of the products and to the lengths burned, measured during sparking, thus presuming, for example, an overlapping of the products to be welded. Overlapping is characterised by partial or complete superposition of the products to be welded before forging and by lower and different absorption of energy in comparison with correct sparking before forging. The knowledge of the energy as a function of the displacement 94 (FIG. 9.c) as close as possible to the weld seam allows pertinent diagnoses based on digital analyses characterising this curve. Indeed, the quantity of burnt material during sparking ought to be proportional to the displacement in the absence of losses.

It is also possible to calculate for determined time periods the energy yields for the primary/secondary (Eₘ/Eₚ), secondary/jaws (Eₘ/Eₛ), primary/jaws (Eₘ/Eₚ), jaws/material (Eₘₐₜ/Eₘ). In sparking, material energy is the heat energy required to increase the temperature and melt the material. It depends on the nature of the product, on its geometry, etc. and can be calculated. When diagnosing the produced weld seams and the welder according to the present invention, this allows to know the abnormal energy losses in the various energy transfers from the primary of the welding transformer(s) to the vicinity of the weld seam. It is thus possible to pertinently diagnose, for example, abnormally resistant passage of the secondary current between the stacks 22, 14, 13, 8, 7, 21, 23 (FIG. 1), or an unbalance in the energy output between two welding transformers supplying a secondary welding circuit (FIG. 9.a).

Moreover, the signals are acquired at speeds such that they allow detailed analysis of the phenomena which accompany the butt welding process and the characteristic time interval of which is typically between 0.1 and 1 millisecond (FIG. 4.a) when a sinusoidal alternating voltage with a frequency of 50 or 60 Hz is supplying the primary of the welding transformer(s).

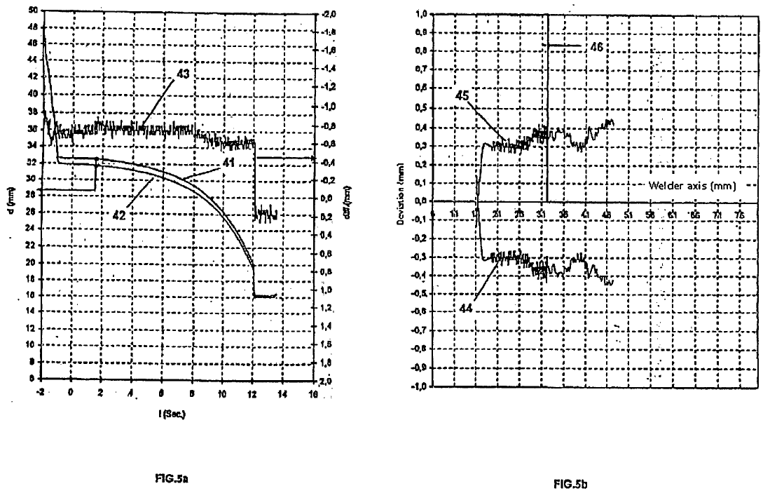

Analysis is not limited to the electric signals but also includes analysis of the displacement of the mobile die measured at several locations 41, 42 (FIG. 5.a), and of the differential displacement 43 (FIG. 5.a). Moreover, the calculated deviations 292, 293 (FIG. 2) are displayed at 44, 45 (FIG. 5.b). These deviations represent the difference, at two determined points, between the position of the real axis and that of the theoretical axis. The theoretical axis 291 (FIG. 2) is perpendicular to the theoretical axis 9 of the welder, while the real axis 29 passes through the attachment points 294, 295 (FIG. 2) of the position sensors on the mobile die. The signal 46 (FIG. 5.b) indicates the start of welding (value changing from 0 to 1). The deviations such as defined provide information on the obliquity of the mobile die during its displacement.

A mechanical diagnosis will be established on the basis of the above measurements and calculations. Drift monitoring of the above measurements is also performed. It is thus possible to diagnose mechanical problems: obliquity of the mobile die, offset of the die, mechanical stresses, etc. These measurements will serve as a basis for the development of a computer diagnostic screen available to the operator after each weld seam has been formed. The monitoring (diagnostic) screen includes for example pushbuttons accessible to the operator, either directly or via a mouse. It can be a touch screen, for example.

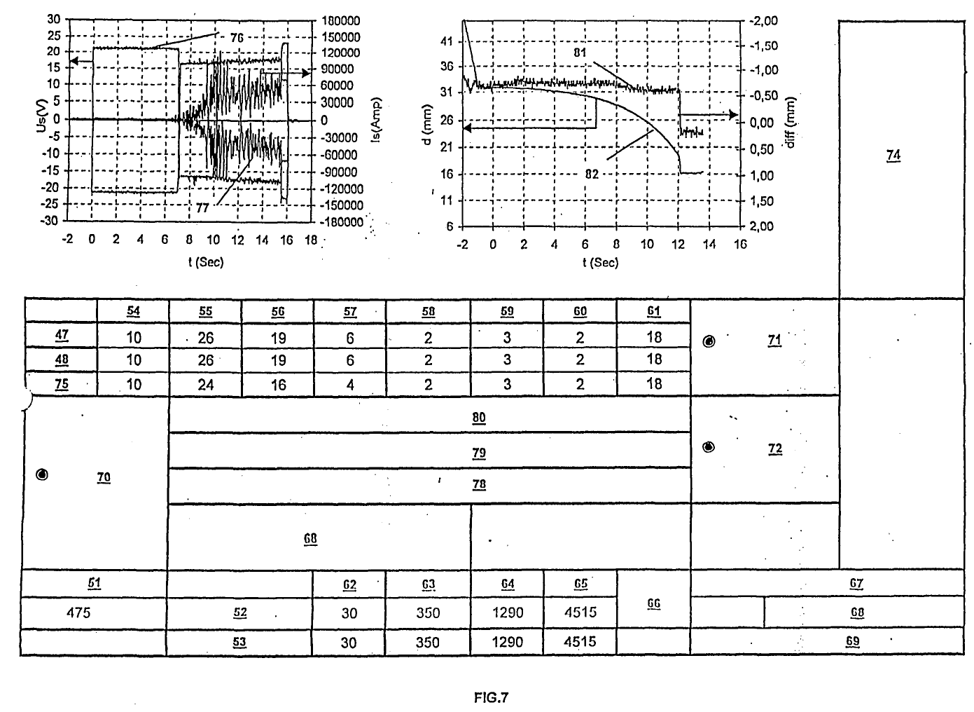

The electric and mechanical analyses, which are complementary by their nature, impart to the diagnosis an appreciable degree of reliability, while the particular characteristics of some of them increase the choice of pertinent criteria characterising the reliability of the weld seam. Thus, for example, unbalanced distribution of sparking energy, which can be calculated on the basis of electric measurements in the secondary circuits of the welding transformer (FIG. 4.b), is often followed by poor forging, the latter being quantified on the basis of the measurements supplied by the displacement sensors 26 (FIG. 2) of the mobile die. Furthermore, the quantification of the bonds during the sparking period is obtained on the basis of a search for a local maximum among instantaneous measurements of the secondary current during successive time periods equal to the cyclic period of the voltage supplying the primary. The number of times that these current maxima exceed a percentage threshold (e.g. 75%) of the maximum forging current is counted. The number obtained then allows to qualify the defect on the basis of the reached value. In a manner that is known per se, bonding increases the risk of presence of oxidised material within the weld seam. Thus it will be noted that this way of quantifying the defect neither depends on the geometry of the product nor on the characteristics of the sinusoidal voltage supplying the primary and constitutes a major advantage of the present invention that gives it a universal character in this case. In the spark welding process, since the sparking phase precedes forging, the bonding defect can thus only be revealed once the weld seam has been formed. The expression “real-time” used in the present description should be understood as corresponding to a duration or time period including at least the duration required to form a weld seam and not exceeding said duration by more than five seconds, for example. It has been mentioned above that the result of a diagnosis will be known after the weld seam has been formed and will be immediately presented in a form that is convenient to the operator before the weld seam leaves the butt-welding station. In the case of a bonding defect, for example, the text displayed at 79 of 80 (FIG. 7) is “Significant bonding before forging”, the text displayed at 68 (FIG. 7) is “Weld seam to be checked” and the box 74 changes to red.

The monitoring of the initial, intermediate and final positions of the mobile die, of the forged lengths and of the hydraulic pressures is performed in an absolute manner. The monitoring of the intermediate positions and of the forged lengths is influenced by an encoding error or by erroneous automatic sending of the basic data on the products to be welded; thickness, width, section to be welded and weldability of each product. However, the operator can test a diagnosis immediately after welding on the basis of data that may be more pertinent, and can immediately benefit from the result without redoing the weld seam.

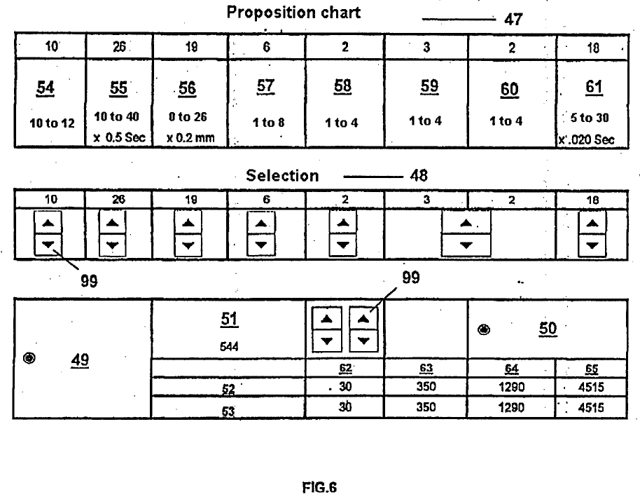

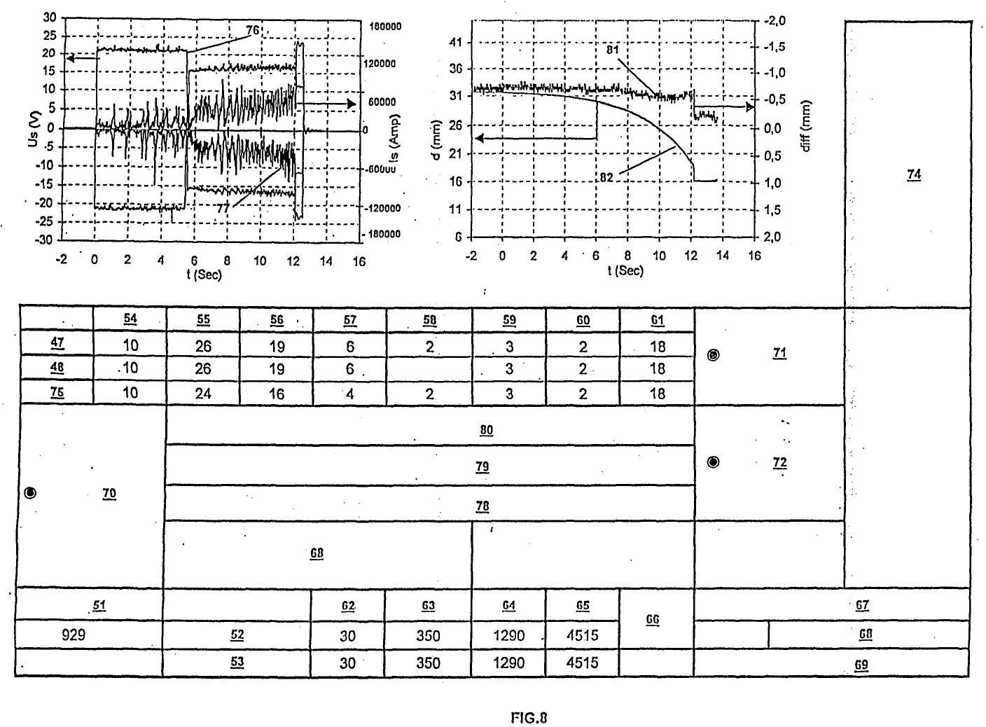

FIG. 6 gives an example of a diagnostic screen that can be displayed before and after a weld seam has been formed. The diagnosis can thus be tested by changing the basic data (weldability 62, thickness 63, width 64 and section to be welded 65) without for all that redoing the welding operation. Starting with the button 49, the operator can modify said basic data upon each new sequence 51, for the strip head (52) and strip tail (53). He can then return to the screen in FIG. 7 or 8, referred to as the “process screen”, by pressing button 50. The diagnosis is displayed at 78, 74 (FIG. 7 or 8) for the new basic data introduced and their parameters, in the form of a text caption (78) and a visual indicator (74), which can be green (Ok) or red (NOk).

The screen in FIG. 6 also allows the operator to modify the automatically proposed values 47 (“10”, “26”, “19”, etc.) before welding in the intermediate part, referred to as the parameter selection part 48, by means of double arrow keys 99 (↑ and ↓). In this case, diagnosis will be based on these modified parameters instead of the values for the welding parameters 54, 55, 56, 57, 58, 59, 60, 61 proposed in the first line 47 (“10”, “26”, “19”, etc.). In the preferred embodiment of the invention considered here, the welding parameters, which are well known to the person skilled in the art, are the high voltage percentage 54, the welding time 55, the forging stroke 56, the contact 57 (selection of the value of the secondary voltage), the cam 58 (convexity of the displacement curve), the final space 59, the spacing bar 60 and the number of cycles 61, respectively.

The analysis of bonds (and microbonds) and of the distribution of the unbalanced sparking energy are performed in a relative manner, thus avoiding being influenced by an encoding error or by erroneous automatic sending of basic data on the products to be welded (thickness, width, section to be welded and weldability of each product).

Analysis of the weld seam is directly performed at the end of the latter and the results emerging from this analysis are immediately available and presented in a form convenient for the operator before the weld seam leaves the butt-welding station (FIG. 7 or 8).

When the basic data 62, 63, 64, 65 have been introduced, either manually or automatically, values for the welding parameters 54, 55, 56, 57, 58, 59, 60, 61 are generated and can be displayed (FIG. 6). In the example considered here, after the weld seam has been formed, the “process” diagnostic screen (FIG. 7 or FIG. 8) is presented on demand or automatically. This screen is essentially subdivided into three parts. As in FIG. 6, the lower part displays the characteristics of the numerical sequence 51, with the basic data 62, 63, 64, 65. This part likewise contains the total number of formed weld seams 66, the status of the last weld seam 68 (“weld seam to be checked” or “suspect weld seam” or “weld seam Ok”), the number of the last recorded weld seam 67 and the caption of the file for storing the data 69. As in FIG. 6, the intermediate zone of the screen likewise contains the values of the parameters of the process 54, 55, 56, 57, 58, 59, 60, 61 (FIG. 7 or 8) for the “Proposition Chart” 47 and the “Selection” 48. The parameters actually measured (“Measurements” 75) are also shown. If necessary, this screen furthermore allows a certain number of interventions by the operator using pushbuttons: “Enter data for next weld seam if necessary—click here” 70, “Validation after welding—wait for following weld seam” 71, “Zoom forging” 72. The upper part of the screen shows the diagrams of the voltage and current envelopes respectively of the secondary as a function of time 76, 77, possibly with a note on the number of bonding cycles at the beginning of the process and before forging (not shown), as well as the displacement characteristics of the die 81, 82. The cause of the inadequacy for any weld seam, in this case or in other cases, is likewise mentioned in the form of a comment 78 (e.g.: “Significant bonding before forging>0.12 s: increase welding time+6”).

This manner of proceeding allows the operator to redo the weld seam if this proves necessary and thus to avoid a break in the treatment process which follows butt welding (FIG. 7).

The diagnostic screen in FIG. 8 is identical to that in FIG. 7 (bonds), but relates to a good-quality weld seam. The status 68 is “Weld seam Ok”. There is no more note at 78.

The diagnosis is based in particular on the analysis of the signals of sensors which are not used to ′regulate the welding machine. This only makes the diagnosis more pertinent.

The analysis of the signals is not limited to diagnosis of the weld seam; it also allows diagnosis of the electromechanical state of the tool. For the record, reference will be made to the diagram in FIG. 5.a representing displacement of the mobile die in the course of time at two different locations 41, 42 and the differential displacement 43. Reference will likewise be made to the diagram in FIG. 5.b, which illustrates the obliquity of the mobile die as a function of its position upon each displacement of the latter. Moreover, the operator can have at his disposal a screen showing the various adjustments made over time by the engineers when changing die as well as the pressure adjustments of the hydraulic accumulators. These values can be followed by comments (see the example in Table 1). It is the choice of locations at which the measurements are taken and the different evaluations of these (FIGS. 1, 2 and 3) which allows to prolong the processing of the data and to end up with a diagnosis of the various constituents of the tool: the transformer(s), the stacks, the dies and the displacement mechanisms. A precise and real calculation and energy balance are likewise carried out: energy at the primary and secondary of the transformer(s), energy supplied to the jaws, etc.

A control assistance for welding is likewise provided by the development of propositions for the welding parameters, some of which are given in the list below, which is not exhaustive:

welding time if this choice is available;

value of the current or primary and/or secondary energy if these choices are available;

forging stroke;

value of the overshoots;

choice of the voltage of the secondary if this choice is available;

choice of the displacement curve and its convexity if this choice is available;

time at high voltage relative to time at low voltage during sparking if this choice is available;

number of voltage cycles during which the voltage is maintained after forging has started;

the firing angles of the thyristors controlled in the various welding phases;

the sparking stroke if available, etc.

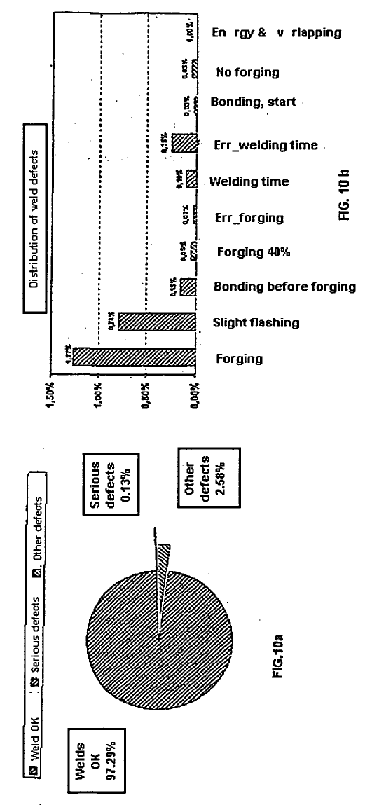

A file summarising the weld seam analysis is also created by the diagnostic system and stored in memory after each weld seam (see the example in Table 3). Storage in memory of the data from each weld seam is also carried out and allows the reconstruction of the “diagnostic screens” which have previously been put at the disposal of the welder operators and to do this on an IT equipment of the “development station” type. This storage also allows to carry out a more in-depth study of each weld seam and hence to improve the pertinence of the diagnoses carried out. On said development station, statistical analyses are performed on a large number of formed weld seams, and new rules relating to butt welding operations are developed, more especially for types of steel that are supposedly difficult to weld. Moreover, a summary screen is made available for the purpose of displaying these statistics with different types of diagrams, such as pie charts (FIG. 10.a), histogram (FIG. 10.b), Pareto-type diagram, etc. Details of the welding defects can likewise be shown on the same screen (see the example in Table 2).

During maintenance and mechanical adjustments, the process according to this invention is very useful, since it enables them to be stored in memory and to be used in order to calibrate, in particular, the position sensors required for diagnosis. It would thus be possible to analyse the effect of the various adjustment parameters on the quality of the formed weld seam. Monitoring of the wearing parts, such as the dies, etc, and of the mechanical interventions is also performed (Table 1). Thus, the screen illustrated by Table 1 is part of the “diagnostic screens” available to the operator of the welder, in particular.

Finally, the device allows all the interventions performed on the machine to be stored in memory and taken into account for a drift analysis between two services (Table 1).

TABLE 1

| CHANGES OF DIES | | | | | ######## Last die No.: 1 | |
|---|---|---|---|---|---|---|
| | | MEASUREMENT ADJUSTMENT | | | | |
| | | INPUTS BY ENGINEERS | | | | |
| | Jaw | 8 mm | 76 mm | 8 mm | 76 mm | Theoretical values |
| DATE | N^{o} | Operator side | | Motor side | | Remarks |
| 02/12/1999 | 3 | 8.20 | 76.30 | 8.10 | 76.20 | Without touching |
| | | | | | | nuts |
| 02/12/1999 | 1 | 8.08 | 76.03 | 8.03 | 75.95 | |
| 23/12/1999 | 1 | 7.90 | 75.76 | 8.00 | 75.88 | |
| 23/12/1999 | 2 | 8.06 | 75.97 | 8.08 | 75.97 | Without touching |
| | | | | | | nuts |
| 13/01/2000 | 2 | 7.85 | 75.93 | 8.00 | 75.94 | |
| 13/01/2000 | 3 | 8.09 | 76.15 | 8.13 | 76.00 | Nut adjustment |
| 03/02/2000 | 3 | 7.85 | 76.30 | 7.98 | 76.10 | Altimetry Ok |
| 03/02/2000 | 1 | 8.15 | 76.01 | 8.30 | 76.20 | Nut adjustment |

HYDRAULIC
Ideal pressure accus (nitrogen)
60 bars
Actions

| DATE | Measures |
|---|---|
| 30/12/1999 10:00 | 31.35 |
| 30/12/1999 11:00 | 60.00 |

TABLE 2

| | | | | Real-time information for the operator of the welder on |
|---|---|---|---|---|
| | | | | the diagnostic screen for each weld seam |
| Weld seam Ok | 3843 | 97.29% | Weld seam Ok | |
| Suspect weld seam | 50 | 1.27% | Forging | Forging stroke: deviation between measurement and selection |
| | | | | (>25% + 0.2 mm & <40%) |
| Suspect weld seam | 31 | 0.78% | Slight sparking | Slight sparking (without adjustment) (no sparking, high voltage, |
| | | | | presentation) |
| Suspect weld seam | 6 | 0.15% | Bonding before | Significant bonding before forging (>0.12 s): increase |
| | | | forging | welding time (+6) |
| Weld seam to be | 2 | 0.05% | 40% forging | Forging stroke: significant deviation between measurement |
| checked | | | | and selection (40%) |
| Suspect weld seam | 1 | 0.03% | Forging error | Forgot to enter new data (checking of results possible |
| | | | | after weld seam has been formed) |
| Suspect weld seam | 4 | 0.10% | Welding time | Welding time: deviation between measurement and selection |
| Suspect weld seam | 10 | 0.25% | Welding time error | Forgot to enter new data (checking of result possible |
| | | | | after weld seam has been formed) |
| Weld seam to be checked | 1 | 0.03% | Initial bonding | Significant bonding at the start (>0.22 s) |
| Weld seam to be checked | 2 | 0.05% | No forging | No forging |
| Weld seam to be checked | 0 | 0.00% | Energy & overlap | Insufficient energy (and/or overlapping) |
| Total weld seams | 3950 | 100.00% | | |

TABLE 3

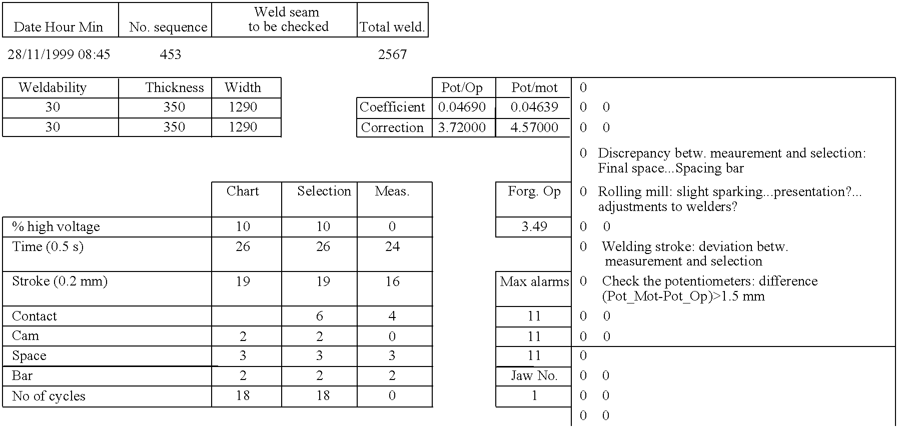

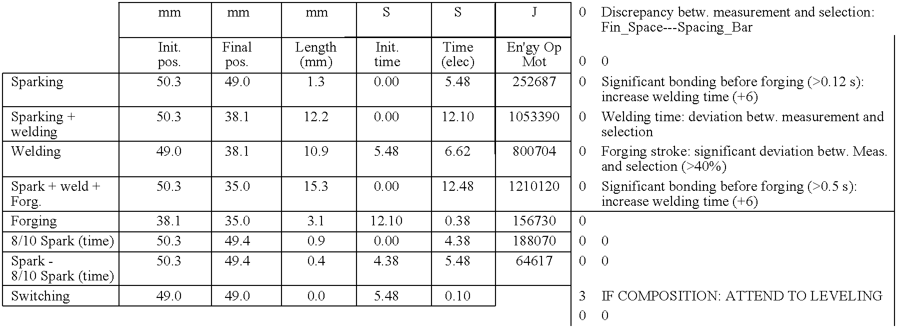

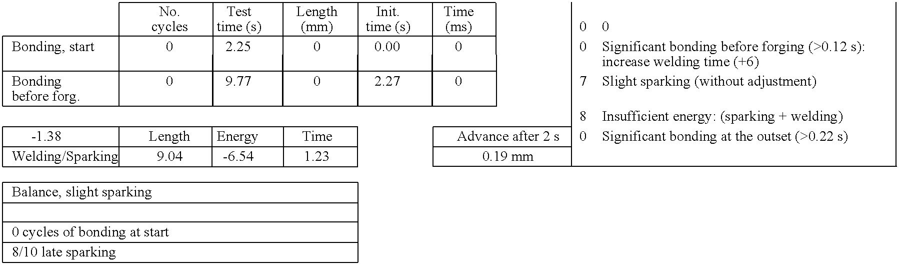

1. Process for the acquisition of data in the form of measurements and calculations, for real-time dynamic diagnosis and decision assistance for an electric direct spark butt welder and for the weld seams obtained by means of said welder; said welder being incorporated into a preferably continuous steel production process, and comprising at least one transformer including at least one primary circuit and at least one secondary circuit as well as a clamping device with dies (3, 4), of which one die (3) is fixed and one die (4) is mobile, allowing to maintain at least two pieces to be welded (1, 2) and inserted in series in the secondary circuit of the transformer (10), said secondary circuit furthermore including at least one secondary winding (12) of said transformer (10), input and output connections of the secondary winding (A, B), stacks (22, 14, 13, 8, 7, 21, 23), said dies (3, 4) and jaws (5, 6), the primary and secondary circuits being provided with current and voltage sensors; comprising the following steps:
measurement of the instantaneous alternating voltage (19, 33), which is preferably sinusoidal, at the terminals of the primary of the transformer of the welder;
measurement of the instantaneous alternating voltage at the terminals of the secondary (16, 35, 36) of the transformer and between the jaws (18, 39) of the dies of the welder;
measurement of the instantaneous current in the primary (24, 34) and the secondary (17, 37, 38) of the transformer;
measurement of the instantaneous displacement (41, 42) of the mobile die (4) at at least two points (294, 295);
storage in memory of said voltages, said currents and said displacement in memory during the welding process;
calculation of the energy supplied by the primary as a function of time;
calculation of the energy supplied by the secondary, preferably to the jaws, as a function of time;
calculation of the energy supplied by the secondary to the jaws as a function of the displacement of the mobile die;
calculation of the heat energy dissipated during sparking, referred to as material energy, as a function of the displacement of the mobile die;
calculation of the secondary/primary, jaw/secondary, jaw/primary and jaw/material energy yield for at least a given duration;
on the basis of said measurements and said calculations, automatic establishment of a real-time dynamic diagnosis (68, 74, 78, 79, 80), with or without the interactive intervention of an operator, as regards the quality of at least one weld seam that has just been formed on said welder.

2. Process according to claim 1, characterised in that it furthermore includes the following steps:
calculation of the energy supplied by the primary for at least a given duration;
calculation of the energy supplied by the secondary for at least a given duration;
calculation of the energy supplied by the secondary to the jaws for at least a given duration.

3. Process according to claim 1 or 2, the mobile die (4) of said welder being actuated in the direction of the fixed die (3) by means of hydraulic cylinders (281), themselves actuated by a hydraulic control circuit (27), a differential-pressure sensor (28) being arranged on the cylinders (281), a pressure sensor (274) being arranged at the outlet of hydraulic accumulators (271), two linear sensors (26) being arranged in the space between the jaws (5, 6), preferably the lower jaws; furthermore including the following steps:
instantaneous measurement of the displacement (41, 42) of the mobile die (4) at at least two points and calculation of the differential displacement (43);
instantaneous measurement of the pressure (274) at the outlet of the hydraulic accumulators (271);
instantaneous measurement of the differential pressure (28) applied to the displacement cylinders (281);
storage in memory of said displacement and of said pressures during the welding process;
as a function of said displacement, calculation of the deviation (44, 45), referred to as obliquity, of the mobile die (4) at at least two points (294, 295), relative to a theoretical axis (291) that is perpendicular to the theoretical welding axis (9);
calculation of the mechanical welding forces during the sparking and forging phases.

4. Process for the acquisition of data in the form of measurements and/or calculations according to any one of claims 1 to 3, characterised in that said data are displayed on a computer screen, a control monitor or a processing station, preferably in colour, and evaluated in the form of an automatic diagnosis (68, 74, 78, 79, 80).

5. Process according to claim 4, characterised in that the display of said data and their evaluation in the form of diagnosis (68, 74, 78, 79, 80) allows an operator to visualise and/or analyse them in real time and constitutes for said operator a decision assistance with a view to validating or rejecting the weld seam which has just been formed.

6. Process according to claim 4 or 5, characterised in that, immediately after the welding operation, a new diagnosis is established on the basis of more pertinent data, preferably introduced by said operator and preferably linked to the geometry (63, 64, 65) and weldability (62), the result of which is immediately obtained without redoing the weld seam.

7. Process according to any one of the preceding claims, characterised in that a curve for the energy dissipated as a function of displacement (94) is obtained, preferably at a location as close as possible to the weld seam, said curve being used immediately after welding and/or subsequently for digital analyses leading to energy-related diagnoses.

8. Process according to claim 6 or 7, characterised in that the operator evaluates the quality of forging and the number of welding defects, preferably bonds and microbonds.

9. Process according to claim 6, characterised in that the weld seam can be rejected on the basis of quality and redone by the operator without the pieces to be welded having left the welding station to continue the production process.

10. Process according to claim 4, characterised in that the display of the data allows the operator to analyse them in real time and to emit a diagnosis on the electromechanical state of the welder.

11. Process according to claim 5, characterised in that a decision to validate or reject the weld seam that has just been formed is automatically taken in real time without the intervention of the operator.

12. Process for the detection, quantification and qualification of bonding defects before forging, according to any one of the preceding claims, characterised in that it includes the following steps:
search for local maxima in the curve (77) formed by the measurements of instantaneous secondary current taken during successive time periods corresponding to the cyclic period of the voltage supplying the primary of the transformer;
counting, during sparking, of the number of times that said current maxima exceed a fixed percentage of the maximum forging current;
qualification of said defect on the basis of the obtained value.

13. Process according to any one of the preceding claims, characterised in that a file of said data is created and stored in memory for each formed weld seam.

14. Process according to any one of the preceding claims, characterised in that quality statistics are established on a large number of formed weld seams, said statistics being displayed and recording the nature and the number of the welding defects.

15. Process according to any one of the preceding claims, characterised in that signals are acquired at a rate such that, when a sinusoidal alternating voltage with a frequency of 50 or 60 hertz is supplying the primary of the transformer, the characteristic acquisition time interval is between 0.01 and 2 ms, and preferably between 0.1 and 1 ms.

16. Process according to any one of the preceding claims, characterised in that the maintenance work performed on the welder is stored in memory.

17. Process according to any one of the preceding claims, characterised in that direct spark welding is applied to a continuous or discontinuous steel production process.

18. Process according to any one of the preceding claims, characterised in that direct spark welding is performed using alternating, pulsed, quasi-direct or direct current.

19. Process according to any one of the preceding claims, characterised in that direct spark welding is applied to products with a round, square or rectangular section, to flat strips or to tubular products.

20. Device for displaying electronic data, preferably a computer screen, a control monitor or a development station, said data being obtainable by means of the process according to any one of the preceding claims, or introduced by an operator, preferably with a keyboard, characterised in that the device includes at least:
one zone for displaying a diagram (X, Y),
one zone which features basic data on the products to be welded (62, 63, 64, 65) for a new welding sequence (51, 52, 53), after automatic introduction or introduction by said operator of said data, said basic data of the products to be welded being, for the strip head (52) and the strip tail (53), the weldability (62), thickness (63), width (64) and section of sheet to be welded (65), and
one diagnostic zone including values (47) for predetermined welding parameters (54, 55, 56, 57, 58, 59, 60, 61), the same parameters selected if necessary by the operator (48) and the same parameters actually measured (75).

21. Device according to claim 20, characterised in that the predetermined welding parameters are selected from the group comprising the high voltage percentage (54), the welding time (55), the forging stroke (56), the contact of the transformer (57), the cam (58), the final space (59), the spacing bar (60) and the number of cycles (61).

22. Device according to claim 20 or 21, characterised in that it includes a display zone indicating the quality status of the weld seam (68, 74).

23. Device according to claim 22, characterised in that, in the case where the quality of the weld seam is inadequate, the device is provided with a display zone (78, 79, 80) indicating the cause of this inadequacy.

24. Device according to any one of claims 20 to 23, characterised in that statistics relating to a large number of weld seams already formed are displayed in diagrams.

25. Device according to claim 24, characterised in that said diagrams are pie charts, histograms or Pareto-type diagrams.

26. Device for implementing a process for the acquisition of data, for real-time dynamic diagnosis and for decision assistance for an electric direct spark butt welder and for the weld seams obtained by means of said welder, according to any one of claims 1 to 19, characterised in that it comprises means for:
measuring the instantaneous alternating voltage (19, 33), which is preferably sinusoidal, at the terminals of the primary of the transformer of the welder;
measuring the instantaneous alternating voltage at the terminals of the secondary (16, 35, 36) of the transformer and between the jaws (18, 39) of the dies of the welder;
measuring the instantaneous current in the primary (24, 34) and the secondary (17, 37, 38) of the transformer;
measuring the instantaneous displacement (41, 42) of the mobile die (4) at at least two points (294, 295);
storing in memory said voltages, said currents and said displacement during the welding process;
calculating the energy supplied by the primary as a function of time;
calculating the energy supplied by the secondary, preferably to the jaws, as a function of time;
calculating the energy supplied by the secondary to the jaws as a function of the displacement of the mobile die;
calculating the heat energy dissipated during sparking, referred to as material energy, as a function of the displacement of the mobile die;
calculating the secondary/primary, jaw/secondary, jaw/primary and jaw/material energy yield for at least a given duration;
automatically establishing, on the basis of said measurements and said calculations, a real-time dynamic diagnosis (68, 74, 78, 79, 80), with or without the interactive intervention of an operator, as regards the quality of at least one weld seam that has just been formed on said welder and/or as regards the electromechanical state of said welder.

27. Electric direct spark butt welder, on which the process according to any one of claims 1 to 19 is implemented.

28. Electric direct spark butt welder, comprising a device for displaying electronic data according to any one of claims 20 to 25.

29. Use of a welder according to claim 27 or 28, for direct spark butt welding of steel strip in a continuous process, preferably pickling or continuous rolling.
